(19) United States
(12) Patent Application Publication
(10) Pub. No.: US 2011/0017958 A1
(43) Pub. Date: Jan. 27, 2011

(54) ORGANIC TRANSPARENT ELECTROCONDUCTIVE MATERIAL, INK FOR FORMING ORGANIC TRANSPARENT ELECTROCONDUCTIVE MATERIAL, AND METHODS FOR PRODUCING THEM

(75) Inventors: Katsuyoshi HOSHINO, Chiba-shi (JP); Yoshiyasu TANAKA, Chiba-shi (JP); Keisuke KUSANO, Chiba-shi (JP); Takeshi CHIBA, Chiba-shi (JP); Takenori IZUMIZAWA, Ichihara-shi (JP); Minako KUBO, Ichihara-shi (JP)

Correspondence Address: J C PATENTS, 4 VENTURE, SUITE 250, IRVINE, CA, 92618, US

(73) Assignees: NATIONAL UNIVERSITY CORPORATION CHIBA UNIVERSITY, Chiba (JP); CHISSO CORPORATION, Osaka (JP)

(21) Appl. No.: 12/765,181

(22) Filed: Apr. 22, 2010

(30) Foreign Application Priority Data
Apr. 24, 2009 (JP) 2009-107096

(51) Int. Cl. H01B 1/22

(52) U.S. Cl. 252/512

(57) ABSTRACT

A method for producing a transparent electroconductive material, the method comprising a step of contacting poly(N-alkylcarbazole) with a metal, said poly(N-alkylcarbazole) is obtained by polymerizing at least one kind of N-alkylcarbazole represented by the following general formula,

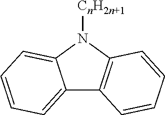

wherein n represents an integer of 1 or more, and at least one hydrogen in the alkyl may be replaced by at least one group selected from hydroxyl, carboxyl, sulfo and amino.

### BACKGROUND OF THE INVENTION

1. Field of the Invention

The present invention relates to an organic transparent electroconductive material, an ink for forming an organic transparent electroconductive material, and methods for producing them.

2. Background Art

A transparent electroconductive material is used in a display panel of an image displaying apparatus, such as liquid crystal display, an electroluminescence display and an electrochromic display, and a panel for a solar cell, and is utilized as an electrode for voltage application or charge injection. A transparent electroconductive material is also used widely for a touch-sensitive panel as a two-dimensional information input device. It is also expected to be applied to an electroconductive or antistatic plastic packing material having transparency, which suppresses static charge from occurring and facilitates visual confirmation of the packed item owing to the transparency of the packing material.

A panel containing a glass substrate or a plastic sheet having accumulated thereon a thin film of a metallic oxide, such as indium tin oxide (ITO), indium zinc oxide (IZO) or fluorine-doped tin oxide (FTO), as a transparent electroconductive material, has been used. However, tight supply-demand balance may occur in indium used in the metallic oxides due to resource depletion. The materials for the metallic oxides involve high cost of forming into a film, and a considerable part of the production cost, for example, of an organic electroluminescence (EL) device or an organic solar cell is occupied by the metallic oxide film. Furthermore, the metallic oxides are poor in electronic or chemical interaction with an organic substance, and thus a problem occurs, for example, in charge injection efficiency to a charge transporting layer in an organic EL device.

Under the circumstances, such an attempt has been proposed, for example, in JP-A-7-219697, JP-A-2000-123658 and JP-A-3-167590 where an electroconductive film is formed with a material containing electroconductive fine particles dispersed in a transparent polymer. In recent years, such an attempt has been proposed, for example, in JP-A-2002-60736 where a thin film of a polythiophene solvent-soluble electroconductive polymer is coated on a substrate.

In the method using electroconductive fine particles, however, the electroconductive fine particles are difficult to be dispersed homogeneously in the transparent polymer due to the strong interaction among the electroconductive fine particles. Furthermore, the method involves a problem that in the process of coating the resulting polymer solution on a substrate, the electroconductive fine particles are associated by the shearing force upon coating. In the method using an electroconductive polymer, it is difficult to obtain a completely colorless and transparent film since the electroconductive polymer itself is colored slightly. Accordingly, a film obtained therefrom is conspicuously colored when the thickness of the film thereof is increased.

In order to solve the problems, the inventors have found that a transparent electroconductive film is obtained by forming a carbazole film by electrolytic polymerization, which is then made in contact with a metal, as described in JP-A-2007-165199. According to the method, a transparent electroconductive film having high transparency can be obtained, but it is necessary to peel off the film from a substrate as an electrode since the film is formed by electrolytic polymerization. Furthermore, there is a practical problem that considerable scaling up is necessary for providing a film with a large area since the film is formed on a substrate. Thus, there is a demand of further improvement toward the practical use.

### SUMMARY OF THE INVENTION

An object of the present invention is to provide a transparent electroconductive material and an ink for forming a transparent electroconductive material that have favorable transparency and electroconductivity and can be easily produced. Other objects and advantages of the invention will be apparent from the following description.

As a result of earnest investigations made by the inventors for solving the problems, it has been found that the problems can be solved by contacting poly(N-alkylcarbazole) with a metal, and thus the invention has been completed.

The present inventions include the following aspects (1) through (9).

(1) A method for producing a transparent electroconductive material, the method comprising a step of contacting poly(N-alkylcarbazole) with a metal, said poly(N-alkylcarbazole) is obtained by polymerizing at least one kind of N-alkylcarbazole represented by the following general formula,

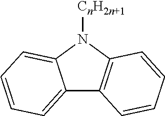

wherein n represents an integer of 1 or more, and at least one hydrogen in the alkyl may be replaced by at least one group selected from hydroxyl, carboxyl, sulfo and amino.

(2) The method for producing a transparent electroconductive material according to the item (1), wherein the step of contacting poly(N-alkylcarbazole) with a metal is performed in a liquid phase.

(3) The method for producing a transparent electroconductive material according to the item (1) or (2), wherein the metal used in the step of contacting poly(N-alkylcarbazole) with a metal is a molten metal.

(4) The method for producing a transparent electroconductive material according to one of the items (1) to (3), wherein poly (N-alkylcarbazole) is obtained by chemical polymerization.

(5) A transparent electroconductive material produced by the method according to one of the items (1) to (4).

(6) A method for producing an ink for forming a transparent electroconductive material, the method comprising steps of: a) dissolving poly (N-alkylcarbazole) in a solvent to form a poly(N-alkylcarbazole) solution, said poly(N-alkylcarbazole) is obtained by polymerizing at least one kind of N-alkylcarbazole represented by the following general formula,

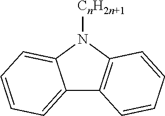

wherein n represents an integer of 1 or more, and at least one hydrogen in the alkyl may be replaced by at least one group selected from hydroxyl, carboxyl, sulfo and amino; and b)contacting said solution with a metal.

(7) A method for producing an ink for forming a transparent electroconductive material, the method comprising a step of contacting a poly(N-alkylcarbazole) solution with a metal, said poly(N-alkylcarbazole) solution is obtained by chemical polymerization of at least one kind of N-alkylcarbazole represented by the following general formula in a solvent,

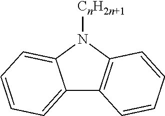

wherein n represents an integer of 1 or more, and at least one hydrogen in the alkyl may be replaced by at least one group selected from hydroxyl, carboxyl, sulfa and amino.

(8) The method for producing an ink for forming a transparent electroconductive material according to the item (6), wherein poly(N-alkylcarbazole) is obtained by chemical polymerization.

(9) An ink for forming a transparent electroconductive material produced by the method for producing an ink for forming a transparent electroconductive material according to one of the items (6) to (8).

According to the invention, such transparent electroconductive material and ink for forming a transparent electroconductive material are obtained that have favorable transparency and electroconductivity and can be easily produced.

### BRIEF DESCRIPTION OF THE DRAWINGS

FIG. 1 is a diagram showing an NMR spectrum of N-n-octylcarbazole.

FIG. 2 is a diagram showing an NMR spectrum of poly(N-n-octylcarbazole).

FIG. 3 is a diagram showing transmission spectra of a poly(N-n-octylcarbazole) film before vapor-deposition of tin and after vapor-deposition of tin.

FIG. 4 is a diagram showing transmission spectra of a poly (N-n-heptylcarbazole) film before vapor-deposition of tin and after vapor-deposition of tin.

FIG. 5 is a photograph showing a poly (N-n-heptylcarbazole) film before vapor-deposition of tin (A) and after vapor-deposition of tin (B).

FIG. 6 is a diagram showing transmission spectra of a poly(N-n-nonylcarbazole) film before vapor-deposition of tin and after vapor-deposition of tin.

FIG. 7 is a diagram showing transmission spectra of a spin-coated poly (N-n-octylcarbazole) film having been made in contact with a tin vapor-deposited film in a 1,2-dichloroethane solution, and a sole spin-coated poly(N-n-octylcarbazole) film.

FIG. 8 is a diagram showing transmission spectra of a spin-coated poly (N-n-octylcarbazole) film having been made in contact with a commercially available aluminum vapor-deposited Mylar film in a 1,2-dichloroethane solution, and a sole spin-coated poly(N-n-octylcarbazole) film.

FIG. 9 is a diagram showing transmission spectra of spin-coated poly(N-n-octylcarbazole) films each having been made in contact with granulated magnesium and granulated zinc respectively in chloroform.

FIG. 10 is a diagram showing transmission spectra of spin-coated poly(N-n-octylcarbazole) films each having been made in contact with granulated indium and granulated gallium respectively in chloroform.

FIG. 11 is a diagram showing transmission spectra of spin-coated poly(N-n-octylcarbazole) films each having been pressed onto molten gallium and molten gallium-indium alloy respectively.

FIG. 12 is a diagram showing a transmission spectrum of a spin-coated poly (N-ethylcarbazole) film having been made in contact with granulated aluminum in chloroform.

FIG. 13 is a diagram showing transmission spectra of a spin-coated poly(N-n-docosylcarbazole) film having been made in contact with granulated tin in chloroform, and a sole spin-coated poly(N-n-docosylcarbazole) film.

FIG. 14 is a diagram showing vacuum ultraviolet photoelectron spectra of poly(N-n-octylcarbazole) and poly (N-n-docosylcarbazole).

### DESCRIPTION OF EMBODIMENTS OF THE INVENTION

Embodiments of the invention will be described below.

In the invention, a polymer of N-alkylcarbazole having a polymerization degree of 2 or more obtained by polymerization of N-alkylcarbazole is referred to as poly (N-alkylcarbazole)

The method for producing a transparent electroconductive material according to the invention contains a step of making poly(N-alkylcarbazole), which is obtained by polymerization of at least one kind of N-alkylcarbazole represented by the following general formula, in contact with a metal.

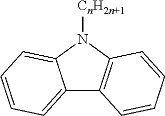

In the general formula, n represents an integer of 1 or more, and at least one hydrogen in the alkyl (CₙH₂ₙ₊₁) may be replaced by at least one group selected from hydroxyl, carboxyl, sulfo and amino. The carbon atom connected to the N-position of carbazole is preferably a primary carbon atom or a secondary carbon atom.

The poly(N-alkylcarbazole) used in the invention may be a homopolymer obtained by polymerizing one kind of N-alkylcarbazole or may be a copolymer obtained by copolymerizing two or more kinds of N-alkylcarbazole. The poly(N-alkylcarbazole) may be one kind of poly(N-alkylcarbazole) or may be a mixture of two or more kinds of poly(N-alkylcarbazole) each having alkyls with different numbers of carbon atoms.

The poly(N-alkylcarbazole) is colored having low transparency and can be a transparent electroconductive material or an ink for forming a transparent electroconductive material by the method according to the present invention.

Examples of the poly(N-alkylcarbazole) include a tetramer and a dimer represented by the following formulae, respectively.

In the formulae, n has the same meaning as the aforementioned general formula. The polymerization degree of the poly(N-alkylcarbazole) is preferably from 2 to 1,000, and from the standpoint of transparency and strength, is more preferably from 4 to 100, and particularly preferably from 4 to 22.

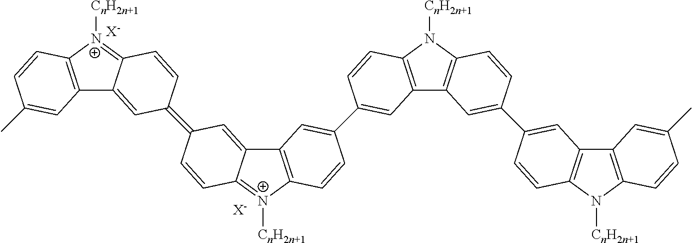

X⁻=ClO₄⁻, BF₄⁻, PF₆⁻, NO₃⁻, SO₄²⁻, Cl⁻, Br⁻, I⁻, etc.

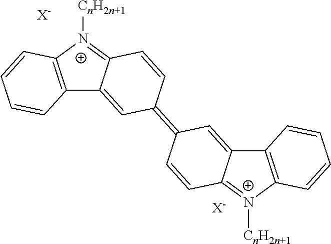

Step of Contacting with a Metal

In the production method of the invention, the poly(N-alkylcarbazole) is contacted with a metal, thereby making the electroconductive film transparent. The kind of metal used in said contacting step is not particularly limited, and a metal having a work function that is smaller than the ionization potential of the poly(N-alkylcarbazole) is preferably used therewith for performing reaction. Specific examples of the metal include aluminum, indium, zinc, titanium, manganese, iron, copper, silver, tin, antimony, sodium, magnesium, gallium, potassium, calcium and alloys of them. Among these, aluminum, tin, zinc, indium and gallium are particularly preferably used.

Examples of the method of contacting the poly(N-alkylcarbazole) with the metal include a vapor deposition method, a sputtering method, a plating method, an electrodeposition method, an electron beam method, a mechanochemical method, a method of making contact with a molten metal, and a liquid phase contact method, in which a metallic vapor deposition film or metallic powder is added to a solution having the poly(N-alkylcarbazole) dissolved therein. The molten metal referred in the invention is a metal that is in a molten state at a temperature equal to or higher than the melting point of the metal.

The step of contacting can be sufficiently performed simply by making the poly(N-alkylcarbazole) in physical contact with the metal. The poly (N-alkylcarbazole) to be made in contact with the metal maybe in such a form as a film produced by electrolytic polymerization described later, powder (solid state) produced by chemical polymerization described later, and a solution containing the film or powder dissolved in an organic solvent. The poly(N-alkylcarbazole) used in the invention has high solubility in an organic solvent and can be present in the form of a poly(N-alkylcarbazole) solution. Accordingly, the poly(N-alkylcarbazole) is preferably contacted with the metal in a liquid phase, thereby producing the ink for forming a transparent electroconductive material described later.

Polycarbazole is insoluble in a solvent, and thus in a conventional production method of a transparent electroconductive material, a polycarbazole film is produced by electrolytic polymerization. In this method, however, a polycarbazole film is necessarily once formed on an electroconductive substrate, and thereafter a metal is vapor-deposited on the thus formed film to produce a transparent electroconductive material. Accordingly, a large-size film is difficult to be produced, and a polycarbazole film formed on an electroconductive substrate is necessarily peeled off from the electroconductive substrate. Thus, for practical application, it is still necessary to facilitate production of a transparent electroconductive material.

On the other hand, poly(N-alkylcarbazole) has high solubility in an organic solvent, and a solution containing poly(N-alkylcarbazole) dissolved in an organic solvent can be applied to a method of making the solution in contact with metal in a liquid phase, thereby producing a transparent electroconductive material. In this case, the solution obtained after contacting the poly (N-alkylcarbazole) solution with a metal can be used as an ink for forming a transparent electroconductive material. A transparent electroconductive material can be easily formed from the ink only by coating the ink. Furthermore, even in the case where poly(N-alkylcarbazole) is formed as a film on an electroconductive substrate by the conventional electrolytic polymerization, the poly(N-alkylcarbazole) film can be dissolved in an organic solvent, such as chloroform, without peeling off physically from the electroconductive substrate, and thus poly(N-alkylcarbazole) can be recovered by dissolving.

Upon making poly(N-alkylcarbazole) in contact with a molten metal, powder of poly(N-alkylcarbazole) or a solution of poly(N-alkylcarbazole) may be contacted with a molten metal to forma transparent electroconductive material, or in alternative, a film of poly (N-alkylcarbazole) is formed first, and then the film may be contacted with a molten metal to form a transparent electroconductive material.

Specifically, after forming a film of poly(N-alkylcarbazole), a molten metal is coated on the resulting film, which is maintained at a temperature equal to or higher than the melting point of the molten metal, thereby producing easily a transparent electroconductive film according to the invention.

The metal used as the molten metal is preferably a metal or an alloy having a melting point of 200° C. or less, and more preferably a metal or an alloy having a melting point of 30° C. or less, for preventing the poly(N-alkylcarbazole) film from suffering thermal deterioration. Specific examples of the metal or alloy include: gallium (melting point: 29.8° C.); alloy (melting point: 15.7° C.) of gallium (75.5% by weight) and indium (24.5% by weight); alloy (melting point: 5° C.) of gallium (62% by weight), indium (25% by weight) and tin (13% by weight); alloy (melting point: 13° C.) of gallium (67% by weight), indium (29% by weight) and zinc (4% by weight); alloy (melting point: 20° C.) of gallium (92% by weight) and tin (8% by weight); alloy (melting point: 25° C.) of gallium (95% by weight) and zinc (5% by weight); and alloy (melting point: 25° C.) of gallium (95.5% by weight) and silver (4.5% by weight). After coating the molten metal, while maintaining the film to a temperature equal to or higher than the melting point of the molten metal, the film is applied with a pressure, thereby accelerating increase of transparency. The application of pressure to the film can be performed, for example, by such a method that a film having a size of 1.5 cm×1.5 cm is formed on a glass substrate and applied with a weight of 1.0 g, which is the weight of the glass substrate itself, and more specifically, a film formed on a glass substrate is placed along with the substrate on a molten metal housed in a vessel with the film facing downward.

In the step of contacting with a metal in the invention, colored poly(N-alkylcarbazole) is contacted with a metal to make the resulting poly(N-alkylcarbazole) colorless. The mechanism of the reaction is that electrons migrate from the metal to the poly(N-alkylcarbazole) with the difference between the ionization potential of the poly(N-alkylcarbazole) and the work function of the metal as the driving force, and the electrons react with cation radicals or dications, which cause coloration of poly(N-alkylcarbazole), to annihilate the cation radicals or dications, thereby making the colored poly(N-alkylcarbazole) colorless. A part of the electrons reduce adsorbed water present inside the poly(N-alkylcarbazole). For migrating electrons from the metal to the poly(N-alkylcarbazole), the work function of the metal is preferably smaller than the ionization potential of the poly(N-alkylcarbazole). The metal thus lacks electrons to be reduced to an ion, the metallic ion is bonded to a counter anion of the cation radical or dication (i.e., an anion dopant) in the poly (N-alkylcarbazole) to form a colorless salt, or contributes to the reduction reaction of adsorbed water to form colorless metallic oxide and hydroxide. In other words, the metal and the poly(N-alkylcarbazole) are subjected to galvanic corrosion reaction to form a salt of the metal and oxide and hydroxide of the metal.

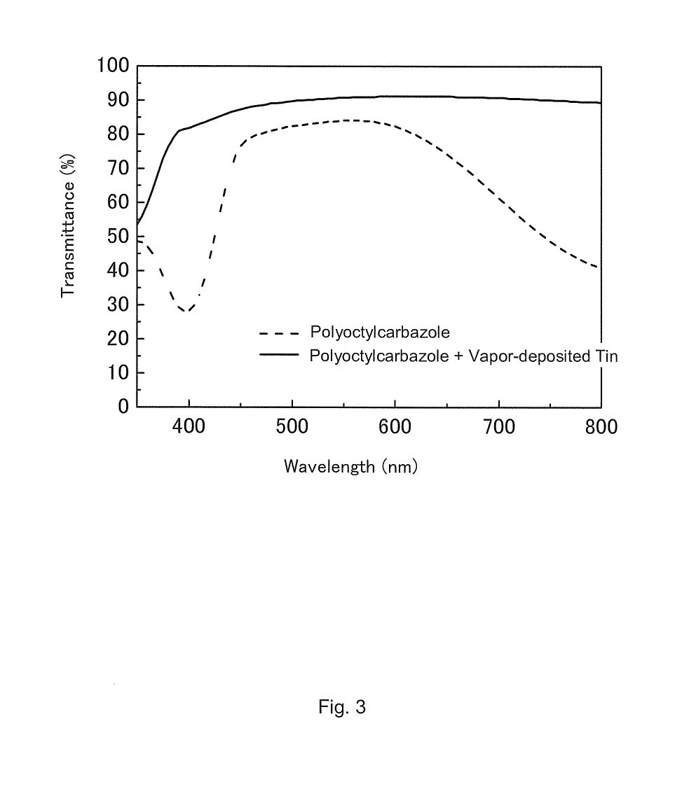

The transparent electroconductive material produced by the production method of the invention has a transmittance of 70% or more in a wavelength range of from 450 to 700 nm in transmission spectrum measurement, and thus has considerably high transparency. As shown in FIGS. 3, 4 and 6, poly(N-alkylcarbazole) is increased in transmittance of the transmission spectrum thereof through contact with a metal. This phenomena can be a criteria whether poly(N-alkylcarbazole) contacted with the metal or not. The transparent electroconductive material of the invention has an electroconductivity of 10⁻⁴ S·cm⁻¹ or more, which shows excellent electroconductivity. The transparent electroconductive material of the invention includes those in the form of a film and of a plate, and the transparent electroconductive material in the form of a film preferably has a thickness of approximately from 50 nm to 0.1 mm, whereas that in the form of a plate preferably may have a thickness exceeding 0.1 mm.

The poly(N-alkylcarbazole) used in the production method of the invention is preferably a polymer obtained by polymerization of N-alkylcarbazole having alkyl bonded to the N-position of carbazole through a primary carbon atom or a secondary carbon atom of the alkyl. The polymer can be formed by electrolytic polymerization of N-alkylcarbazole or can be formed by chemical polymerization thereof. The alkyl of the poly (N-alkylcarbazole) is not particularly limited and may be alkyl having 1 or more carbon atoms (i.e., n in the general formula represents 1 or more). The alkyl preferably has 22 or less carbon atoms (i.e., n in the general formula represents 22 or less) from the standpoint commercial availability. The alkyl preferably has 2 or more carbon atoms (i.e., n in the general formula represents 2 or more) from the standpoint of solubility in an organic solvent. The alkyl more preferably has from 7 to 22 carbon atoms (i.e., n in the general formula represents from 7 to 22). In the alkyl, at least one hydrogen may be replaced by at least one group selected from hydroxyl, carboxyl, sulfo and amino.

### Synthesis of N-alkylcarbazole

The N-alkylcarbazole having alkyl bonded to the N-position of carbazole can be synthesized by dehalogenation hydrogenation reaction of carbazole and halogenated alkyl as an alkylating agent in the presence of a strongly basic alkali metal compound, such as sodium hydride. The N-alkylcarbazole can also be synthesized by dehalogenation potassium reaction of carbazole potassium salt and alkyl halide. In the case where the poly(N-alkylcarbazole) is synthesized by chemical polymerization using an oxidizing agent, the alkyl bonded to the N-position of carbazole is preferably a primary alkyl or a secondary alkyl. In the case where the alkyl bonded to the N-position of carbazole is a tertiary alkyl, the alkyl tends to be detached upon polymerization, and thus the target poly(N-alkylcarbazole) is difficult to be obtained in some cases.

### Alkyl Halide

The alkyl halide as an alkylating agent is available from reagent manufacturers. An alkyl monobromide is preferred from the standpoint of handleability in laboratories, reactivity and richness of variation in alkyl. Specific examples of the available alkyl monobromide include 1-bromopropane, 2-bromopropane, 1-bromobutane, 2-bromobutane, 1-bromo-2-methylpropane, 2-bromo-2-methylpropane, 1-bromo-3-methylbutane, 1-bromohexane, 2-bromohexane, 3-bromohexane, 1-bromomethylpentane, 1-bromoheptane, 3-bromoheptane, 4-bromoheptane, 1-bromo-5-methylhexane, 1-bromo-2-ethylhexane, 1-bromooctane, 2-bromooctane, 1-bromononane, 2-bromononane, 1-bromodecane, 1-bromoundecane, 1-bromododecane, 2-bromododecane, 1-bromotridecane, 1-bromotetradecane, 2-bromotetradecane, 1-bromopentadecane, 1-bromoheptadecane, 1-bromo-2-methylhexadecane, 1-bromooctadecane, 1-bromoeicosane and 1-bromodocosane, which are available, for example, from Tokyo Chemical Industry Co., Ltd., Sigma-Ardrich Japan Co., Ltd., and Lancaster Synthesis, Ltd.

### Synthesis of Alkyl Halide

The alkyl halide other than the aforementioned alkyl monobromides can be obtained by hydrogen halide addition reaction of an alkene. The reaction easily proceeds by adding hydrogen halide to an alkene solution. For obtaining the alkyl halide by hydrogen halide addition reaction of an alkene, an alkyl monoiodide is preferably synthesized by hydrogen iodide addition reaction of an alkene according to the method disclosed in Organic Synthesis, IV, pp. 543-544, John Wiley & Sons, Inc. (1962).

Examples of the available alkene include 3,3-dimethyl-1-butene, 2-hexene, 3-hexene, 4-methyl-1-pentene, 4-methyl-2-pentene, 3,3-dimethyl-1-pentene, 4,4-dimethyl-1-pentene, 2-heptene, 3-heptene, 3-methyl-1-hexene, 4-methyl-1-hexene, 4-methyl-2-hexene, 5-methyl-1-hexene, 5-methyl-2-hexene, 3,3-dimethyl-1-hexene, 3,4-dimethyl-1-hexene, 5-methyl-2-heptene, 5-methyl-3-heptene, 2-octene, trans-3-octene, trans-4-octene, 2-nonene, 4-nonene, 3,3,5-trimethyl-1-hexene, cis-2-decene, cis-4-decene, cis-5-decene, 5-dodecene, 7-tetradecene and cis-9-tricosene, which are available, for example, from Tokyo Chemical Industry Co., Ltd.

Examples of the alkyl monoiodide obtained by hydrogen iodide addition reaction of an alkene include3-iodo-2,2-dimethylbutane, 3-iodohexane, 4-iodohexane, 2-iodo-4-methylpentane, 3-iodo-4-methylpentane, 2-iodo-3,3-dimethylpentane, 2-iodo-4,4-dimethylpentane, 3-iodoheptane, 4-iodoheptane, 2-iodo-3-methylhexane, 2-iodo-4-methylhexane, 3-iodo-4-methylhexane, 2-iodo-5-methylhexane, 3-iodo-5-methylhexane, 2-iododimethylhexane, 2-iodo-3,4-dimethylhexane, 2-iodo-3,4-dimethylhexane, 3-iodo-5-methylheptane, 4-iodo-5-methylheptane, 3-iodooctane, 4-iodooctane, 5-iodooctane, 3-iodononane, 5-iodononane, 2-iodo-3,3,5-trimethylhexane, 3-iododecane, 4-iododecane, 6-iododecane, 8-iodotetradecene and 10-iodotricosane.

### Formation of Poly(N-alkylcarbazole) by Electrolytic Polymerization

The process for forming poly(N-alkylcarbazole) by electrolytic polymerization will be described. The electrolytic polymerization referred herein means polymerization of a polymerizable monomer by application of electricity, and specifically such a method that a monomer and an electrolyte are dissolved in a solvent, and polymerization is performed by application of voltage to electrodes. The electrolytic polymerization does not use a catalyst and thus provides an electroconductive polymer with high purity.

The N-alkylcarbazole thus synthesized by the aforementioned method and a supporting electrolyte are dissolved in a solvent for electrolytic polymerization to prepare a solution containing N-alkylcarbazole.

The concentration of N-alkylcarbazole in the solution is preferably from 0.001 to 50 parts by weight, and more preferably from 0.01 to 17 parts by weight, per 100 parts by weight of the solvent for electrolytic polymerization. In the case where the concentration is 0.001 part by weight or more, such an advantages is obtained that a polymerized film having a continuous structure can be obtained, and in the case where the concentration is 0.01 part by weight or more, the advantage can be conspicuously exhibited. In the case where the concentration is 50 parts by weight or less, such an advantage is obtained that the viscosity of the solution is lowered to perform polymerization reaction with a sufficient reaction rate, and in the case where the concentration is 17 parts by weight or less, the advantage can be conspicuously exhibited.

The solvent for electrolytic polymerization contained in the solution is not particularly limited as far as the solvent can dissolve the N-alkylcarbazole and the supporting electrolyte and can perform electrolytic polymerization, and is preferably a solvent having a relatively high dielectric constant. Examples of the solvent for electrolytic polymerization include a halogenated hydrocarbon, such as dichloromethane, a formamide compound, such as dimethylformamide, a sulfoxide compound, such as dimethylsulfoxide, an ether compound, such as tetrahydrofuran, an alcohol compound, such as methanol, a lactone compound, such as γ-butyrolactone, a pyrrolidone compound, such as N-methyl-2-pyrrolidone, a carbonate compound, such as propylene carbonate, and a nitrile compound, such as acetonitrile. The solvent may be used solely or as a mixture of two or more kinds thereof. Examples of the mixed solvent include a mixture of a perchloric acid aqueous solution and methanol, with which a favorable polycarbazole film can be obtained. The solvent may be used after mixing with water. Specifically, for example, a mixed solvent containing water (25% by volume) and methanol (75% by volume) may be suitably used.

The supporting electrolyte in the solution is not particularly limited as far as the electrolyte does not undergo electrochemical reaction, and is preferably one that does not undergo electrode reaction of the electrolytic polymerization. Examples of the supporting electrolyte include HClO₄, (C₄H₉) ₄N⁺ClO₄⁻, (C₃H₇) ₄N⁺ClO₄⁻, (C₂H₅) ₄N⁺ClO₄⁻, (CH₃) ₄N⁺ClO₄⁻, Li⁺ClO₄⁻, Na⁺ClO₄⁻, K⁺ClO₄⁻, H⁺CLO₄⁻, (C₄H₉) ₄N⁺BF₄⁻, (C₄H₉) ₄N⁺PF ₆⁻, (C₂H₅) ₄N⁺BF₄⁻, (C₂H₅) ₄N⁺PF₆⁻, Li⁺BF₄⁻ and Li⁺PF₆⁻, which may be used solely or as a mixture of two or more kinds thereof. In the case where the solvent contains water, examples of the supporting electrolyte further include NaCl, NaBr, Na₂SO₄, NaNO₃, LiCl, LiBr, LiNO₃, Li₂SO₄, KCl, KBr, KNO₃ and K₂SO₄.

The concentration of the supporting electrolyte is not particularly limited as far as the electrochemical reaction can be performed, and is preferably from 0.001 to 50 parts by weight, and more preferably from 0.01 to 50 parts by weight, per 100 parts by weight of the solvent. In the case where the concentration is 0.001 part by weight or more, such an advantage is obtained that the electric double layer, which is a driving force of the electrolytic polymerization of N-alkylcarbazole, can be sufficiently formed, and in the case where the concentration is 50 parts by weight or less, such an advantage is obtained that the viscosity of the solution is lowered to perform polymerization reaction with a sufficient reaction rate. Specifically, for example, a concentration of 12.6 parts by weight is suitable for a mixed solvent containing water (25% by volume) and methanol (75% by volume).

The method for producing a transparent electroconductive material by electrolytic polymerization contains a step of electrolyzing a solution containing the solvent for electrolytic polymerization, the N-alkylcarbazole and the supporting electrolyte, thereby forming poly(N-alkylcarbazole). The electrolysis can be performed in such a manner that an anode and a cathode are immersed in the solution, and a voltage is applied between the anode and a reference electrode. The electrolysis can also be performed by applying a voltage between the anode and the cathode without the use of a reference electrode.

The anode is an electroconductive material and is preferably a metal that is not dissolved upon electrolysis, and preferred examples thereof include a metal, such as platinum, gold and stainless steel, and an electroconductive carbon material. An electroconductive oxide, such as indium tin oxide (ITO) and tin oxide, electroconductive plastics, and a semiconductor, such as silicon and gallium arsenide (GaAs), may be used depending on the conditions.

The cathode is not particularly limited as far as it is formed of an electroconductive material, and examples thereof include a metal, such as platinum, gold, copper, nickel and stainless steel, an electroconductive oxide, such as indium tin oxide (ITO) and tin oxide, electroconductive plastics, and a semiconductor, such as silicon and gallium arsenide (GaAs).

The voltage applied between the anode and the reference electrode is preferably from +0.5 to +1.8 V, and more preferably from +0.5 to +1.5 V, with respect to the saturated calomel reference electrode. In the case where the potential is too electropositive, the alkyl of the N-alkylcarbazole may be detached to form 9,9′-dicarbazyl, which has low electroconductivity and low durability against application of voltage, in some cases. Furthermore, the solvent for electrolytic polymerization and the supporting electrolyte may be decomposed, thereby providing an unfavorable tendency for the electrolytic polymerization for forming poly(N-alkylcarbazole). In the case where a reference electrode is not used, the voltage applied between the anode and the cathode is preferably from +0.9 to +4 V, and more preferably from +1 to +3 V, owing to the same reasons. In the electrolysis without the use of a reference electrode, the electrolytic polymerization for forming poly(N-alkylcarbazole) can be performed by passing a constant electric current between the anode and the cathode as far as the applied voltage is in the aforementioned range.

The electrolysis of the solution in this embodiment may be performed in the air, but is preferably performed in a nitrogen atmosphere for minimizing the influence of oxygen in the air, and the electrolysis is more preferably performed with nitrogen gas bubbled through the solution.

The electrolysis of the solution in this embodiment is preferably performed, while not limited, at a temperature of from −40 to 40° C. for forming a poly(N-alkylcarbazole) film having a relatively high electroconductivity.

The poly(N-alkylcarbazole) formed through electrolysis is formed in the form of a film on the anode. The thickness of the film depends on the amount of electricity applied and the substituent in the N-alkylcarbazole used as a raw material in the electrolytic polymerization. The thickness of the film may be appropriately controlled depending on necessity, and is preferably from 10 nm to 10 μm, and more preferably from 50 nm to 5 μm, for forming a continuous film and assuring sufficient transparency of a film to be obtained by contacting with a metal. For example, in the case of N-n-octylcarbazole, in which the carbon number of the alkyl in the N-alkylcarbazole represented by the general formula is 8, a poly(N-n-octylcarbazole) film having a thickness of 16 nm is obtained by passing electricity in an amount of 1 mC per 1 cm² of the anode. The thickness of the film is increased in proportional to the amount of electricity applied.

The poly (N-alkylcarbazole) in a solid state obtained by the electrolytic polymerization is then contacted with a metal to form a transparent electroconductive material, and the resulting transparent electroconductive material may be dissolved in a solvent to form an ink for a transparent electroconductive material described later.

### Formation of Poly(N-alkylcarbazole) by Chemical Polymerization

The process for forming poly(N-alkylcarbazole) by chemical polymerization will be described. The chemical polymerization referred herein means oxidation polymerization of a polymerizable monomer by action of an oxidizing agent without the use of an electrifying device. The poly(N-alkylcarbazole) in the embodiment can also be formed by chemical polymerization. Specifically, the poly (N-alkylcarbazole) can be obtained by adding an oxidizing agent to a solution containing N-alkylcarbazole, thereby performing chemical polymerization.

In the chemical polymerization, a solvent having a relatively high dielectric constant is preferably used. Examples of the solvent include dichloromethane, chloroform, acetonitrile, dimethylformamide, dimethylsulfoxide, tetrahydrofuran, methanol, ethanol, γ-butyrolactone, N-methyl-2-pyrrolidone, propylene carbonate, pyridine, dioxane, acetic acid, water and mixtures of them. In the chemical polymerization, a larger amount of N-alkylcarbazole can be dissolved in the solvent, and the concentration of N-alkylcarbazole is preferably from 0.01 to 300 parts by weight, and more preferably from 0.1 to 50 parts by weight, per 100 parts by weight of the solvent. In the case where the concentration is 0.01 part by weight or more, such an advantage is obtained that the productivity of the poly(N-alkylcarbazole) as the product can be enhanced, and in the case where the concentration is 0.1 part by weight or more, the advantage as such can be conspicuously exhibited. In the case where the concentration is 300 parts by weight or less, such an advantage is obtained that the reaction yield of the chemical polymerization can be enhanced, and in the case where the concentration is 50 parts by weight of more, the advantage as such can be conspicuously exhibited.

Examples of the oxidizing agent include a ferric salt, a cerium salt, a dichromate salt, a permanganate salt, ammonium persulfate, boron trifluoride, a bromate salt, hydrogen peroxide, chlorine, bromine and iodine, and among these, a ferric salt is preferred. Examples of the ferric salt include iron(III) perchlorate. The use of iron(III) perchlorate enhances the polymerization degree. The concentration of the oxidizing agent can be appropriately controlled and is not particularly limited, and the concentration is preferably from 0.01 to 500 parts by weight, and more preferably from 0.1 to 100 parts by weight, per 100 parts by weight of the solvent. In the case where the concentration is 0.01 part by weight or more, such an advantage is obtained that the concentration of the oxidizing agent is equivalent to or higher than the N-alkylcarbazole as a raw material, thereby performing the polymerization reaction efficiently, and in the case where the concentration is 0.1 part by weight or more, the advantage as such can be conspicuously exhibited. In the case where the concentration is 500 parts by weight or less, the solution can be prevented from being increased in viscosity, thereby performing the polymerization reaction efficiently, and in the case where the concentration is 100 parts by weight or less, the advantage as such can be conspicuously exhibited.

In the chemical polymerization, the reaction temperature can be appropriately controlled depending on the concentrations of the oxidizing agent and the N-alkylcarbazole and the like, and is not particularly limited, and the temperature is preferably from −100 to 100° C., and more preferably from −80 to 90° C. In the case where the reaction temperature is −80° C. or more, such an advantage is obtained that the electroconductivity of the poly (N-alkylcarbazole) as the product can be increased. In the case where the temperature is 100° C. or less, such an advantage is obtained that the poly(N-alkylcarbazole) can be prevented from suffering crosslinking reaction and peroxidation reaction, thereby preventing the electroconductivity thereof from being decreased. The reaction time can be appropriately controlled as similar to the reaction temperature, and is not particularly limited, and the reaction time within the aforementioned preferred temperature range is preferably from 1 second to 1 week, and more preferably from 1 second to 48 hours.

The solution after completing the chemical polymerization is filtered, washed and dried to provide the poly(N-alkylcarbazole) in a powder form. The steps of filtering, such as suction-filtering, washing and drying may be appropriately performed according to known methods. The powder is made in contact with a metal to form a transparent electroconductive material in a powder form.

In the invention, the poly(N-alkylcarbazole) obtained by polymerization preferably has a polymerization degree of from 2 to 1,000, and is more preferably from 4 to 100, and further preferably from 4 to 22, from the standpoint of transparency and strength.

Ink for forming Transparent Electroconductive Material

According to another embodiment of the present invention, an ink for forming an organic transparent electroconductive material and a method for producing the ink are provided. The ink of the invention is colorless.

As having been described above, the poly(N-alkylcarbazole) has high solubility in a solvent and thus can be formed into a solution by mixing with a solvent. Examples of the solvent include a halogenated hydrocarbon, such as dichloromethane, a formamide compound, such as dimethylformamide, a sulfoxide compound, such as dimethylsulfoxide, an ether compound, such as tetrahydrofuran, an alcohol compound, such as methanol, a lactone compound, such as γ-butyrolactone, a pyrrolidone compound, such as N-methyl-2-pyrrolidone, a carbonate compound, such as propylene carbonate, and a ketone compound, such as acetone. The resulting poly(N-alkylcarbazole) solution is contacted with a metal to provide the ink for forming a transparent electroconductive material of the invention. In the case where the poly(N-alkylcarbazole) is prepared by chemical polymerization, the solution thus prepared by the polymerization may be directly contacted with a metal to provide the ink for forming a transparent electroconductive material of the invention. The contact step can be performed, for example, by immersing a film having a metal vapor-deposited thereon in the solution or by mixing metallic powder with the solution. Upon contacting the poly(N-alkylcarbazole) with a metal in a solution, the metal is preferably used in an amount of from 0.01 to 300 parts by weight per 100 parts by weight of the solution.

The concentration of the ink for forming a transparent electroconductive material of the invention can be controlled to such a range that a film can be formed, and is preferably from 0.01 to 10 parts by weight, and more preferably from 0.1 to 1 part by weight, of the poly (N-alkylcarbazole) per 100 parts by weight of the solvent.

By using the ink for forming a transparent electroconductive material thus produced, a transparent electroconductive material having a desired size can be conveniently produced by such a film forming method as spin coating, screen printing and ink-jet printing, and therefore, such an advantage is obtained that post-processing after producing the transparent electroconductive material can be eliminated.

### EXAMPLE

The invention will be described in more detail with reference to example below, in which transparent electroconductive materials and inks for forming a transparent electroconductive material are produced according to the aforementioned embodiments, and the advantages of the invention are confirmed. The invention is not limited to the examples.

The thickness of the film was measured with a contact film thickness meter (Alpha-Step IQ, available from KLA-Tencor Corporation) or by observation with a scanning electron microscope (SEM) (Model ABT-32, available from Topcon Corporation).

### Synthesis of Alkylating Agent

As the alkylating agent used for producing N-alkylcarbazole, alkyl monobromide compounds were purchased from Tokyo Chemical Industry Co., Ltd., Sigma-Ardrich Japan Co., Ltd., and Lancaster Synthesis, Ltd. Alkylating agents that were not able to be purchased were synthesized by hydrogen iodide addition reaction of an alkene according to examples disclosed in Organic Synthesis, IV, pp. 543-544, John Wiley & Sons, Inc. (1962).

A mixture of 3 equivalents of potassium iodide and 4.3 equivalents of 95% by weight orthophosphoric acid was added to 1 equivalent of an alkene as the raw material, and the mixture was heated to 80° C. for 3 hours under stirring. The 95% by weight orthophosphoric acid was prepared by adding 98% by weight orthophosphoric acid (available from Tokyo Chemical Industry Co., Ltd.) to 85% by weight orthophosphoric acid. After cooling the reaction mixture, water and petroleum ether were added thereto, and the mixture was stirred and then separated. The petroleum ether layer was bleached with 10% by weight sodium thiosulfate, washed with a saturated sodium chloride aqueous solution, and dried over anhydrous sodium sulfate. After evaporating petroleum ether, an alkyl monoiodide was obtained by distillation under reduced pressure.

### Synthesis of N-alkylcarbazole

Carbazole was dissolved in a mixed solvent containing tetrahydrofuran and N, N-dimethylformamide at a volume ratio of 3/1, to which the alkylating agent obtained above (an alkyl bromide or an alkyl iodide) in an amount of 1 equivalent per 1 equivalent of carbazole was added, and a 60% by weight sodium hydride mineral oil dispersion (“Sodium Hydride”, a trade name, available from Kanto Kagaku Co., Ltd.) in an amount corresponding to 1.5 equivalents of sodium hydride was further added gradually thereto under stirring, followed by stirring at room temperature for 1 hour. Methanol was added to the reaction mixture for terminating the reaction until bubbles were not formed, and then the solvent was removed by evaporation under reduced pressure. Dichloromethane was added to the resulting residue, and the solution was washed with 3N hydrochloric acid and water. The solution was dried over anhydrous magnesium sulfate, which was then filtered off. The solvent contained in the resulting filtrate was removed in vacuum, and the residue was purified by silica gel column chromatograph using hexane as a developing solvent.

### Synthesis of N-octylcarbazole

A synthesis method of N-n-octylcarbazole as a monomer used in polymerization of poly(N-n-octylcarbazole) is specifically described.

Carbazole (6.0 g, 0.036 mol, available from Tokyo Chemical Industry Co., Ltd.) was dissolved in a mixed solvent containing tetrahydrofuran (30 mL) and N,N-dimethylformamide (10 mL), to which 1-bromooctane (3.95 g, 0.036 mol, available from Tokyo Chemical Industry Co., Ltd.) was added, and a 60% by weight sodium hydride mineral oil dispersion (2.16 g, 0.054 mol, “Sodium Hydride”, a trade name, available from Kanto Kagaku Co., Ltd.) was further added gradually thereto at room temperature (approximately 20° C.), followed by stirring for 1 hour, thereby completing the reaction.

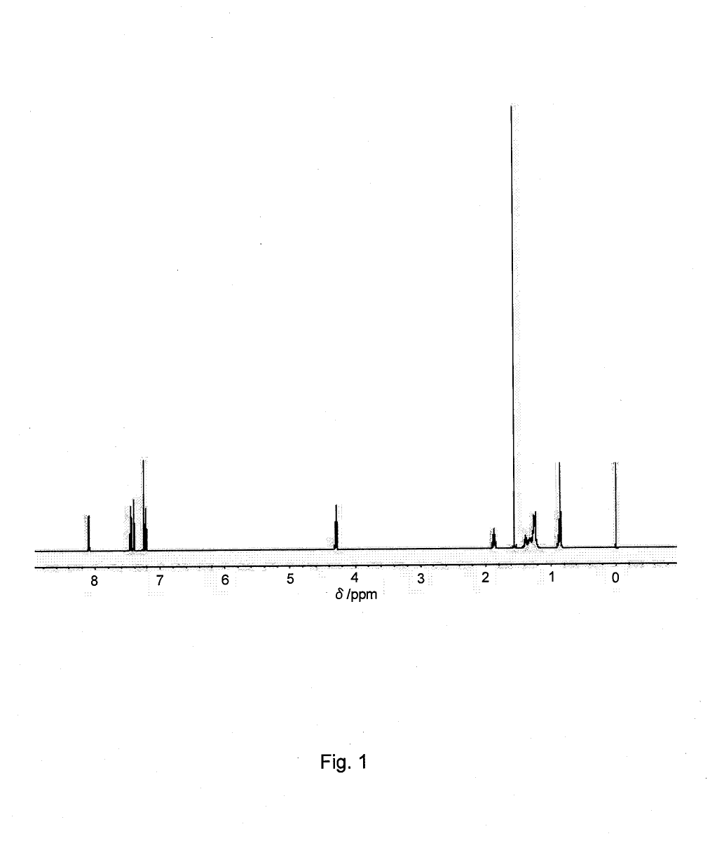

After completing the reaction, methanol was added to the reaction mixture for terminating the reaction until bubbles were not formed. The solvent in the reaction mixture was removed by evaporation under reduced pressure, and the concentrate was extracted with methylene chloride. The resulting organic layer was washed with 3N hydrochloric acid and water, and dried over anhydrous magnesium sulfate, which was then filtered off. Methylene chloride contained in the filtrate was removed with an evaporator, and the residue was purified by silica gel column chromatograph using hexane as a developing solvent. Hexane was removed with an evaporator to provide a transparent liquid (8 g, yield: 80%), which was confirmed as N-n-octylcarbazole by ¹H-NMR. The purity thereof measured with high-pressure liquid chromatography (HPLC) was 99.5%. The resulting NMR spectrum is shown in FIG. 1.

### Example 1

### Synthesis of Poly(N-n-octylcarbazole) by Chemical Polymerization

Synthesis of poly(N-alkylcarbazole) by chemical polymerization is described with reference to poly(N-n-octylcarbazole) as an example.

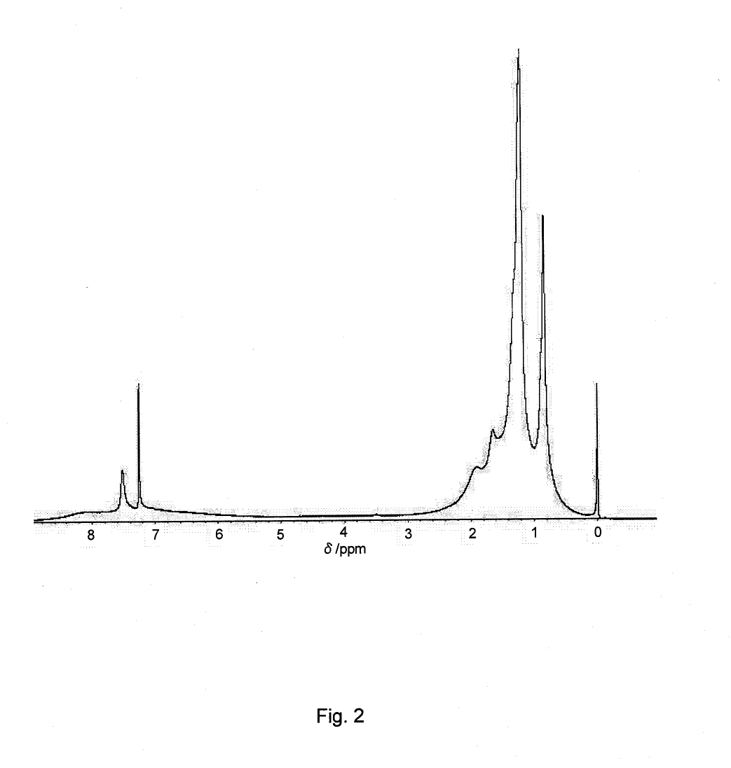

N-n-octylcarbazole (0.14 g, 0.05 mol) as a monomer and iron(III) perchlorate (0.33 g, 0.1 mol) as an oxidizing agent were dissolved in acetonitrile (10 mL), and chemical polymerization was performed by stirring the mixture in a nitrogen atmosphere at room temperature (approximately 20° C.) for 24 hours. The reaction mixture was filtered, and the filtered product was washed with methanol and dried at 40° C. for 1 hour to provide target poly(N-n-octylcarbazole) (0.21 g) as green powder. The NMR spectrum of the poly(N-n-octylcarbazole) is shown in FIG. 2.

### Formation of Poly(N-n-octylcarbazole) Film

0.1 g of the poly(N-n-octylcarbazole) obtained by chemical polymerization was dissolved in 4 mL of chloroform, and the resulting solution was spin-coated on slide glass with a spin-coater (AS-300, available from Able Co., Ltd.) at 1,000 rpm to form a poly (N-n-octylcarbazole) film having a thickness of 100 nm. The transmission spectrum of the resulting poly(N-n-octylcarbazole) film on the slide glass is shown in FIG. 3. The film had a thickness of 100 nm. The film exhibited green color as apparent from the spectrum. The film had an electroconductivity of 7.6×10⁻⁴ S·cm⁻¹ measured by the four-probe method.

### Vapor Deposition of Tin Layer

Tin was vapor-deposited on the green film of poly(N-n-octylcarbazole) to a thickness of 10 nm with a resistance heating vapor deposition apparatus (VPC-260F, available from Ulvac Kiko, Inc.). After vapor-depositing tin, the metallic gloss of the tin layer and the green color of the film were both decolored, thereby being converted to a colorless transparent film. The transmission spectrum of the resulting colorless transparent film is shown in FIG. 3.

### Measurement of Electroconductivity

The colorless transparent film having a thickness of 100 nm was measured for electroconductivity. The electroconductivity was measured by the four-probe method with a resistivity meter, Loresta GP, and a four-probe detector, MCP-TP06P, available from Dia Instruments Co., Ltd. As a result, the electroconductivity was 7.5×10⁻⁴ S·cm⁻¹, which exhibited excellent electroconductive property.

Accordingly, a transparent electroconductive material can be conveniently produced by this example while maintaining favorable colorless transparency and electroconductive property even with a relatively large thickness.

### Example 2

### Formation of Poly(N-n-octylcarbazole) Film

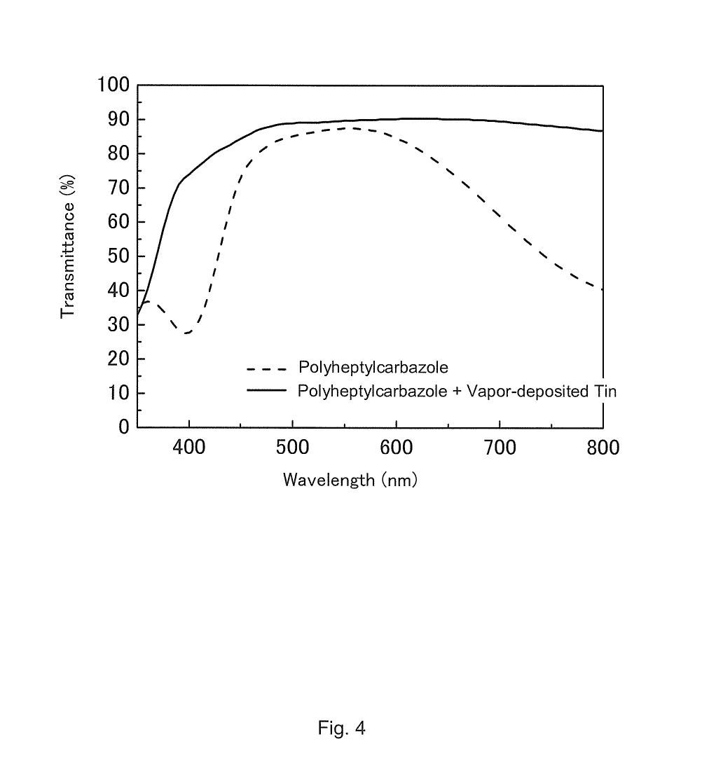

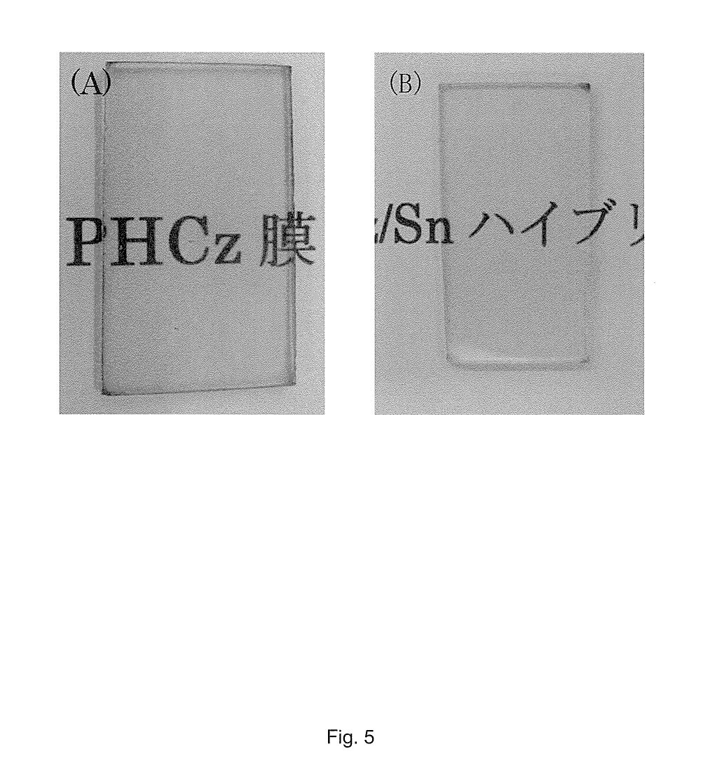

0.1 g of poly(N-n-heptylcarbazole), which was obtained by chemical polymerization of 0.05 mol of n-heptylcarbazole, 0.1 mol of iron(III) perchlorate and 10 mL of acetonitrile, was dissolved in 4 mL of chloroform, and the resulting solution was spin-coated on slide glass with a spin-coater (AS-300, available from Able Co., Ltd.) at 1,000 rpm to form a film. The transmission spectrum of the resulting poly(N-n-heptylcarbazole) film on the slide glass is shown in FIG. 4. The poly(N-n-heptylcarbazole) film exhibited green color as apparent from the transmission spectrum and the photograph in FIG. 5. The film had an electroconductivity of 4.0×10⁻⁵ S·cm⁻¹ measured by the four-probe method.

### Vapor Deposition of Tin Layer

Tin was vapor-deposited on the green film of poly(N-n-heptylcarbazole) to a thickness of 10 nm with a resistance heating vapor deposition apparatus (VPC-260F, available from Ulvac Kiko, Inc.). After vapor-depositing tin, the metallic gloss of the tin layer and the green color of the film were both decolored as shown in the photograph in FIG. 5, thereby being converted to a colorless transparent film. The transmission spectrum of the resulting colorless transparent film is shown in FIG. 4.

### Measurement of Electroconductivity

The colorless transparent film having a thickness of 100 nm was measured for electroconductivity. The electroconductivity was measured in the same manner as in Example 1. As a result, the electroconductivity was 1.4×10⁻⁴ S·cm⁻¹, which exhibited excellent electroconductive property.

### Example 3

### Formation of Poly(N-n-nonylcarbazole) Film

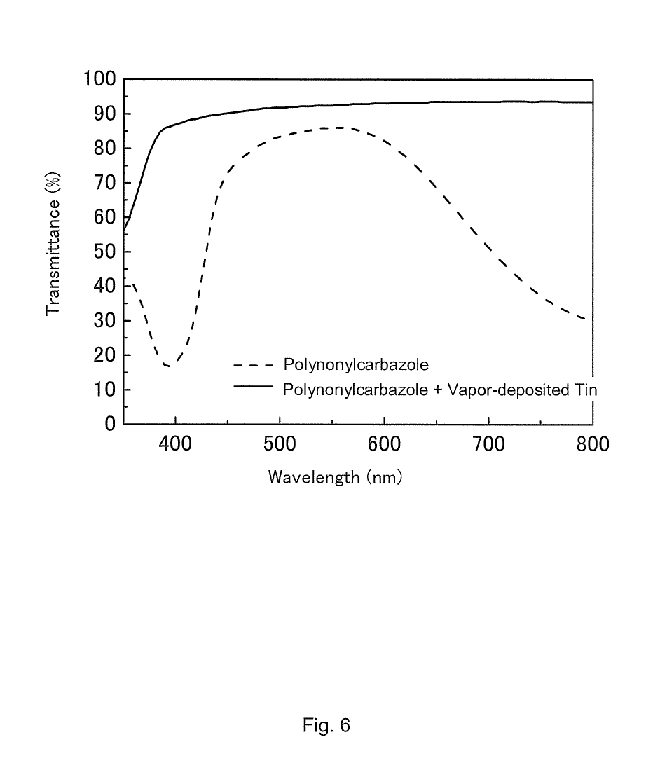

0.1 g of poly(N-n-nonylcarbazole), which was obtained by chemical polymerization of 0.05 mol of n-nonylcarbazole, 0.1 mol of iron(III) perchlorate and 10 mL of acetonitrile, was dissolved in 4 mL of chloroform, and the resulting solution was spin-coated on slide glass with a spin-coater (AS-300, available from Able Co., Ltd.) at 1,000 rpm to form a film. The transmission spectrum of the resulting poly(N-n-nonylcarbazole) film having a thickness of 200 nm on the slide glass is shown in FIG. 6. The poly(N-n-nonylcarbazole) film exhibited green color as apparent from the transmission spectrum. The film had an electroconductivity of 4.0×10⁻⁵ S·cm⁻¹ measured by the four-probe method.

### Vapor Deposition of Tin Layer

Tin was vapor-deposited on the green film of poly(N-n-nonylcarbazole) to a thickness of 10 nm by the resistance heating vapor deposition method. As similar to the poly(N-n-octylcarbazole) film and the poly(N-n-heptylcarbazole) film mentioned above, the metallic gloss of the tin layer and the green color of the film were both decolored after vapor-depositing tin, thereby being converted to a colorless transparent film. The transmission spectrum of the resulting colorless transparent film is shown in FIG. 6.

### Measurement of Electroconductivity

The colorless transparent film having a thickness of 200 nm was measured for electroconductivity. The electroconductivity was measured by the four-probe method with a resistivity meter, Loresta GP, and a four-probe detector, MCP-TP06P, available from Dia Instruments Co., Ltd. As a result, the electroconductivity was 1.4×10⁻⁴ S·cm⁻¹, which exhibited excellent electroconductive property.

### Example 4

Ink for forming Transparent Electroconductive Material

0.1 g of the poly (N-octylcarbazole) obtained by chemical polymerization in Example 1 was dissolved in 4 mL of 1, 2-dichloroethane, to which 90 cm² of a commercially available polyester film (Lumirror, available from Toray Industries, Inc.) having tin vapor-deposited thereon to a thickness of 200 nm with a resistance heating vapor deposition apparatus (VPC-260F, available from Ulvac Kiko, Inc.) was added, thereby producing an ink for forming a transparent electroconductive material. After taking the polyester film out from the ink, tin on the polyester film disappeared, and the green color of the solution changed to grayish black color.

### Formation of Transparent Electroconductive Film

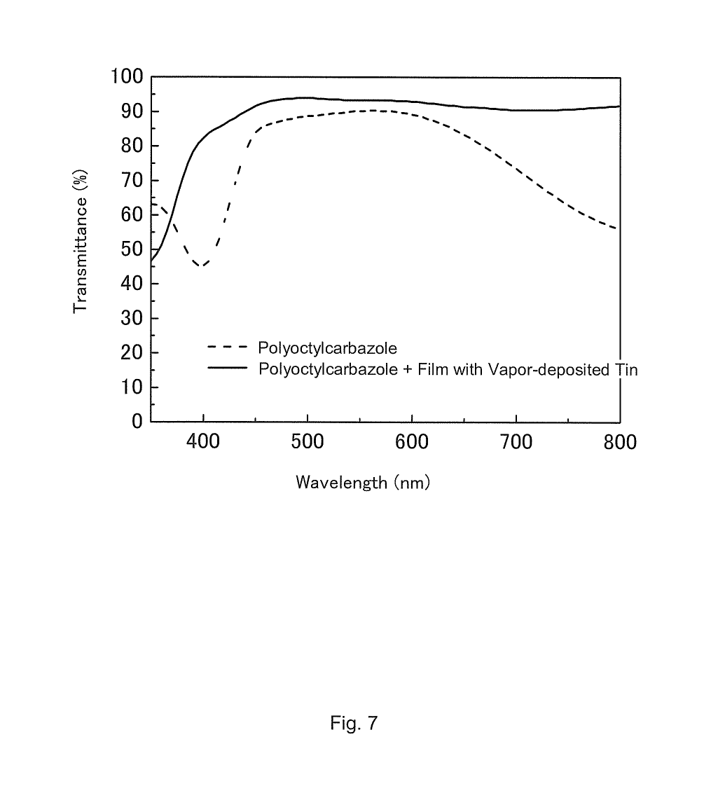

The ink was spin-coated on slide glass with a spin-coater (AS-300, available from Able Co., Ltd.) at 1,000 rpm to form a transparent electroconductive film. The transparent electroconductive film thus produced had a thickness of 100 nm. The transmission spectrum of the film is shown in FIG. 7. The film had an electroconductivity of 9.5×10⁻² S·cm⁻¹ measured by the four-probe method. Thus, it was confirmed that the film exhibited excellent electroconductive property.

### Example 5

Ink for forming Transparent Electroconductive Material

0.1 g of the poly (N-octylcarbazole) obtained by chemical polymerization in Example 1 was dissolved in 4 mL of 1, 2-dichloroethane, to which 75 cm² of a commercially available polyester film having aluminum vapor-deposited thereon to a thickness of 70 nm (Mylar PET Film, available from Teijin DuPont Films Japan, Ltd.) was added, thereby producing an ink for forming a transparent electroconductive material. After taking out the polyester film from the ink, aluminum on the polyester film disappeared, and the green color of the solution changed to grayish black color.

### Formation of Transparent Electroconductive Film

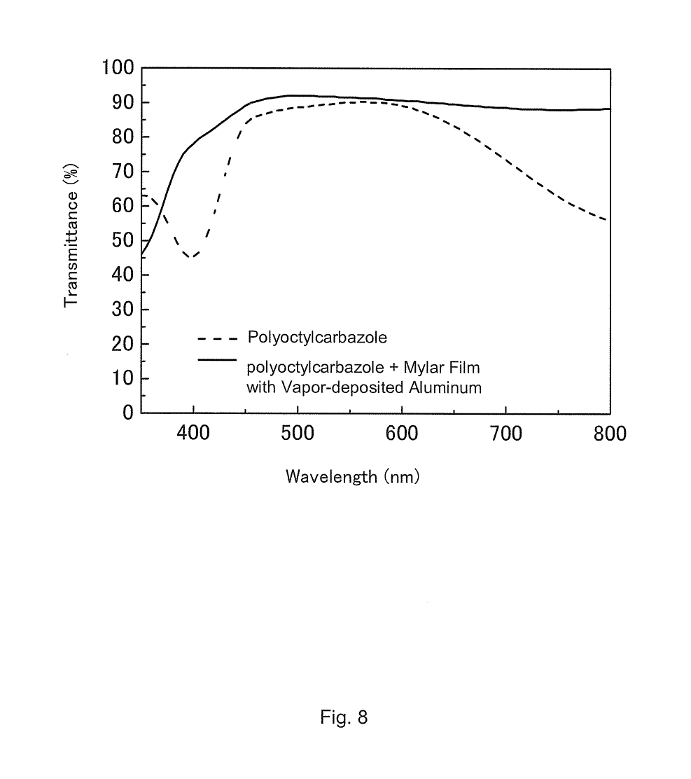

The ink was spin-coated on slide glass with a spin-coater (AS-300, available from Able Co., Ltd.) at 1,000 rpm to form a transparent electroconductive film. The transparent electroconductive film thus produced had a thickness of 100 nm. The transmission spectrum of the film is shown in FIG. 8. The film had an electroconductivity of 4.5×10⁻⁴ S·cm⁻¹ measured by the four-probe method. Thus, it was confirmed that the film exhibited excellent electroconductive property.

### Example 6

Ink for forming Transparent Electroconductive Material

0.1 g of the poly(N-ethylhexylcarbazole) obtained by chemical polymerization of N-ethylhexylcarbazole (available from Sigma-Ardrich Japan Co., Ltd.) in the same manner as in Example 1 was dissolved in 4 mL of 1, 2-dichloroethane, to which 0.15 g of tin in a granular form was added, thereby producing an ink for forming a transparent electroconductive material. Tin thus added was partially dissolved, and the remaining tin granules were removed by filtration. The green color of the solution changed to grayish black color.

### Formation of Transparent Electroconductive Film

The ink was spin-coated on slide glass with a spin-coater (MS-A150, available from Mikasa Co., Ltd.) at 2,000 rpm to form a transparent electroconductive film. The transparent electroconductive film thus produced had a thickness of 100 nm. The film had an electroconductivity of 2.0×10⁰ S·cm⁻¹ measured by the four-probe method. Thus, it was confirmed that the film exhibited excellent electroconductive property.

### Example 7

Ink for forming Transparent Electroconductive Material

0.1 g of the poly(N-n-octylcarbazole) obtained by chemical polymerization in Example 1 was dissolved in 4 mL of chloroform, to which 0.1 g of tin in a granular form was added, thereby producing an ink for forming a transparent electroconductive material. Tin thus added was partially dissolved, and the remaining tin granules were removed by filtration. The green color of the solution changed to grayish black color.

### Formation of Transparent Electroconductive Film

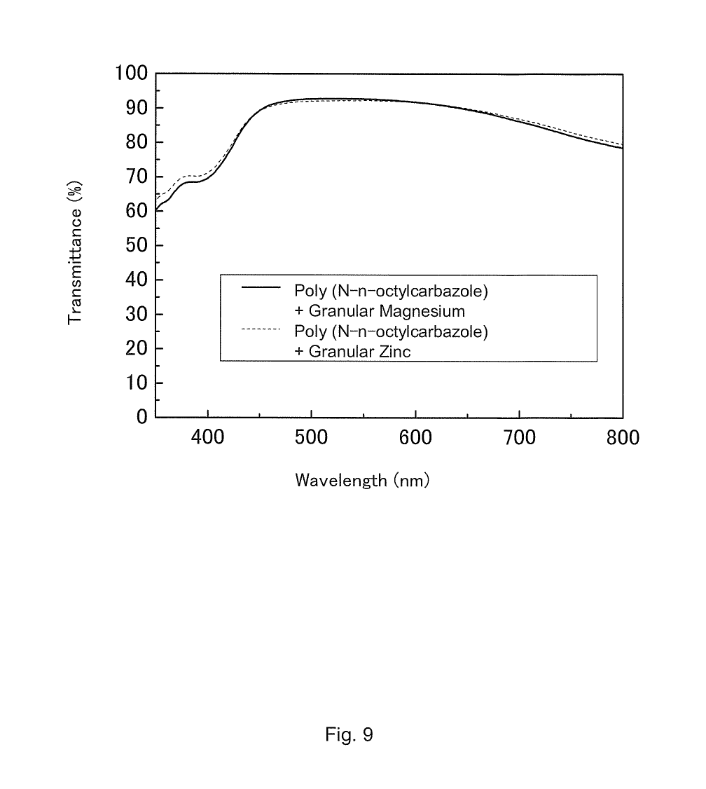

The ink was spin-coated on slide glass with a spin-coater (MS-A150, available from Mikasa Co., Ltd.) at 2,000 rpm to form a transparent electroconductive film. The transparent electroconductive film thus produced had a thickness of 100 nm. The transmission spectrum of the film is shown in FIG. 9. The film had an electroconductivity of 4.0×10⁻³ S·cm⁻¹ measured by the four-probe method. Thus, it was confirmed that the film exhibited excellent electroconductive property.

### Example 8

### Ink for Forming Transparent Electroconductive Material

0.1 g of the poly (N-n-octylcarbazole) obtained by chemical polymerization in Example 1 was dissolved in 4 mL of chloroform, to which 0.25 g of zinc in a granular form was added, thereby producing an ink for forming a transparent electroconductive material. Zinc in a granular form thus added was partially dissolved, and the remaining zinc granules were removed by filtration. The green color of the solution changed to grayish black color.

### Formation of Transparent Electroconductive Film

The ink was spin-coated on slide glass with a spin-coater (MS-A150, available from Mikasa Co., Ltd.) at 2,000 rpm to form a transparent electroconductive film. The transparent electroconductive film thus produced had a thickness of 100 nm. The transmission spectrum of the film is shown in FIG. 9. The film had an electroconductivity of 4.0×10⁻³ S·cm⁻¹ measured by the four-probe method. Thus, it was confirmed that the film exhibited excellent electroconductive property.

### Example 9

Ink for forming Transparent Electroconductive Material

0.1 g of the poly (N-octylcarbazole) obtained by chemical polymerization in Example 1 was dissolved in 4 mL of chloroform, to which 0.35 g of indium in a granular form was added, thereby producing an ink for forming a transparent electroconductive material. Indium in a granular form thus added was partially dissolved, and the remaining indium granules were removed by filtration. The green color of the solution changed to grayish black color.

### Formation of Transparent Electroconductive Film

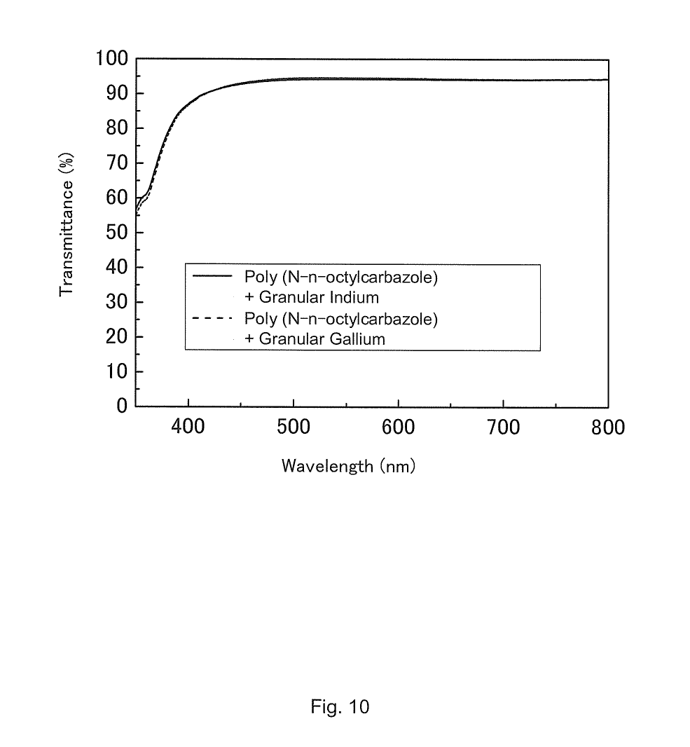

The ink was spin-coated on slide glass with a spin-coater (MS-A150, available from Mikasa Co., Ltd.) at 2,000 rpm to form a transparent electroconductive film. The transparent electroconductive film thus produced had a thickness of 100 nm. The transmission spectrum of the film is shown in FIG. 10. The film had an electroconductivity of 7.1×10⁻³ S·cm⁻¹ measured by the four-probe method. Thus, it was confirmed that the film exhibited excellent electroconductive property.

### Example 10

Ink for forming Transparent Electroconductive Material

0.1 g of the poly (N-n-octylcarbazole) obtained by chemical polymerization in Example 1 was dissolved in 4 mL of chloroform, to which 0.2 g of gallium melted by heating to 40° C. with a dropper, thereby producing an ink for forming a transparent electroconductive material. Gallium thus added was partially dissolved and then solidified in a granular form in the solution. The remaining gallium granules were removed by filtration. The green color of the solution changed to grayish black color.

### Formation of Transparent Electroconductive Film

The ink was spin-coated on slide glass with a spin-coater (MS-A150, available from Mikasa Co., Ltd.) at 2,000 rpm to form a transparent electroconductive film. The transparent electroconductive film thus produced had a thickness of 100 nm. The transmission spectrum of the film is shown in FIG. 10. The film had an electroconductivity of 4.9×10⁻³ S·cm⁻¹ measured by the four-probe method. Thus, it was confirmed that the film exhibited excellent electroconductive property.

### Example 11

Formation of Transparent Electroconductive Film by Pressing onto Molten Metal

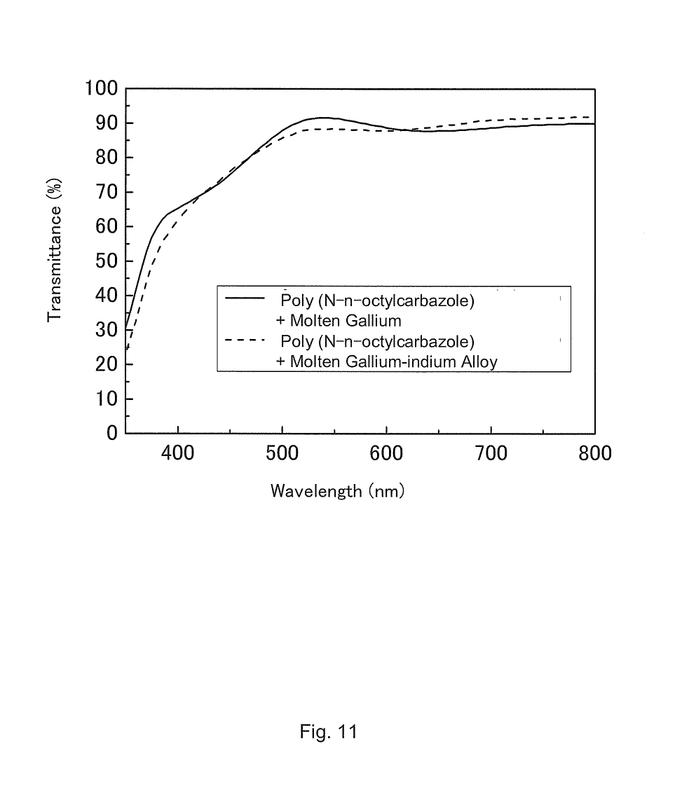

0.1 g of the poly(N-n-octylcarbazole) obtained by chemical polymerization in Example 1 was dissolved in 4 mL of chloroform, and the resulting solution was spin-coated on slide glass with a spin-coater (MS-A150, available from Mikasa Co., Ltd.) to form a film. Molten gallium heated to 40° C. was poured in a tray, on which the slide glass having the poly(N-n-octylcarbazole) film formed thereon, whereby the spin-coated poly(N-n-octylcarbazole) film was pressed onto the molten gallium by utilizing the weight of the slide glass and heated to 40° C. The green color of the spin-coated film changed colorless transparent. The transmission spectrum of the film is shown in FIG. 11. The film had an electroconductivity of 2.0×10⁻³ S·cm⁻¹ measured by the four-probe method. Thus, it was confirmed that the film exhibited excellent electroconductive property.

### Example 12

Formation of Transparent Electroconductive Film by Pressing onto Molten Metal

0.1 g of the poly(N-n-octylcarbazole) obtained by chemical polymerization in Example 1 was dissolved in 4 mL of chloroform, and the resulting solution was spin-coated on slide glass with a spin-coater (MS-A150, available from Mikasa Co., Ltd.) to forma film. An alloy containing 75.5% by weight of gallium and 24.5% by weight of indium melted at room temperature was poured in a tray, on which the slide glass having the poly(N-n-octylcarbazole) film formed thereon, whereby the spin-coated poly(N-n-octylcarbazole) film was pressed onto the molten gallium by utilizing the weight of the slide glass. The green color of the spin-coated film changed colorless transparent. The transmission spectrum of the film is shown in FIG. 11. The film had an electroconductivity of 1.0×10⁻³ S·cm⁻¹ measured by the four-probe method. Thus, it was confirmed that the film exhibited excellent electroconductive property.

### Example 13

### Formation of Transparent Electroconductive Film of Poly (N-ethylcarbazole) Formed by Chemical Polymerization

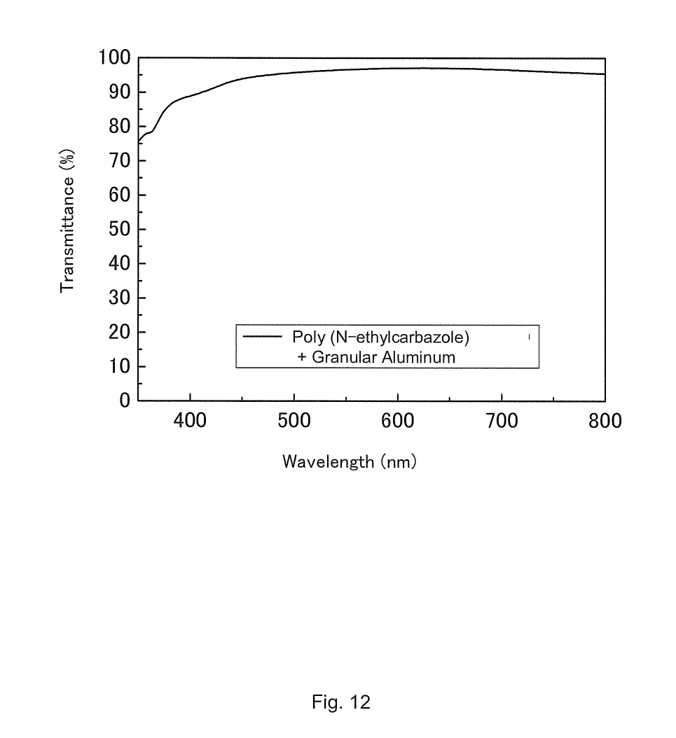

Chemical polymerization of 0.05 mol of n-ethylcarbazole, 0.1 mol of iron (III) perchlorate and 10 mL of acetonitrile was performed under the same conditions as in the preparation of poly (N-n-octylcarbazole) in Example 1. 0.1 g of the resulting poly (N-ethylcarbazole) was dissolved in 4 mL of chloroform, to which 0.15 g of aluminum in a granular form was added. After completing the reaction, the remaining aluminum granules were removed by filtration, thereby producing an ink for forming a transparent electroconductive material. The ink was further filtered with Puradisc Syringe Filter (Model 3784-1302, pore diameter: 0.2 μm, available from Whatman Japan Co., Ltd.) for removing finer impurities, and then spin-coated on slide glass with a spin-coater (MS-A150, available from Mikasa Co., Ltd.) at 2,000 rpm to form a transparent electroconductive film. The transmission spectrum of the film is shown in FIG. 12. The film had an electroconductivity of 2.0×10⁻⁴ S·cm⁻¹ measured by the four-probe method.

### Example 14

### Formation of Transparent Electroconductive Film of Poly(N-n-docosylcarbazole) Formed by Chemical Polymerization

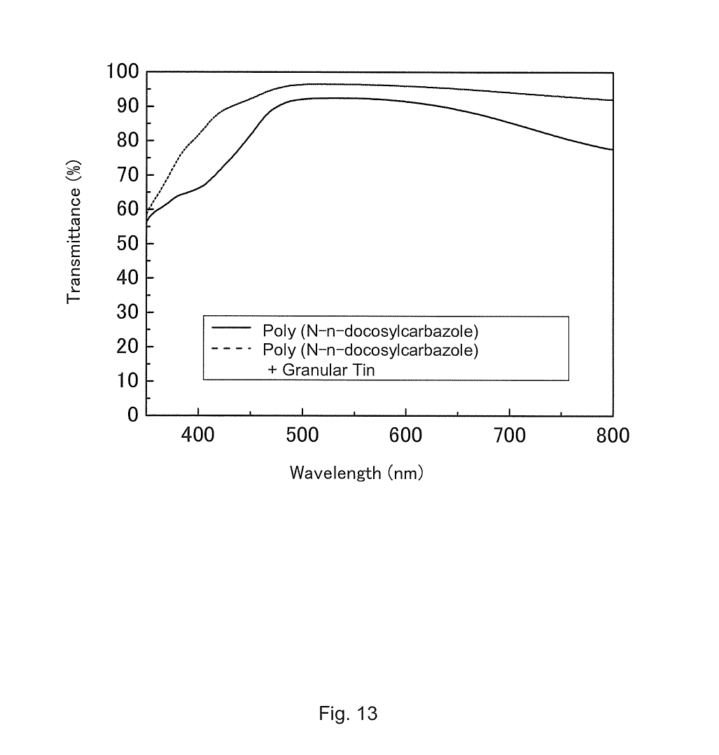

Chemical polymerization of 0.05 mol of n-docosylcarbazole, 0.1 mol of iron(III) perchlorate and 10 mL of acetonitrile was performed under the same conditions as in the preparation of poly(N-n-octylcarbazole) in Example 1. 0.1 g of the resulting poly(N-n-ethylcarbazole) was dissolved in 4 mL of chloroform, to which 0.15 g of tin in a granular form was added. After completing the reaction, the remaining tin granules were removed by filtration, thereby producing an ink for forming a transparent electroconductive material. The ink was spin-coated on slide glass with a spin-coater (MS-A150, available from Mikasa Co., Ltd.) at 2,000 rpm to form a transparent electroconductive film. The transparent electroconductive film thus produced had a thickness of 100 nm. The transmission spectra of the film and the poly(N-n-docosylcarbazole) film are shown in FIG. 13. The film had an electroconductivity of 3.8×10⁻⁴ S·cm⁻¹ measured by the four-probe method.

### Reference Example 15

### Measurement of Ionization Potential of Poly(N-n-octylcarbazole) Film

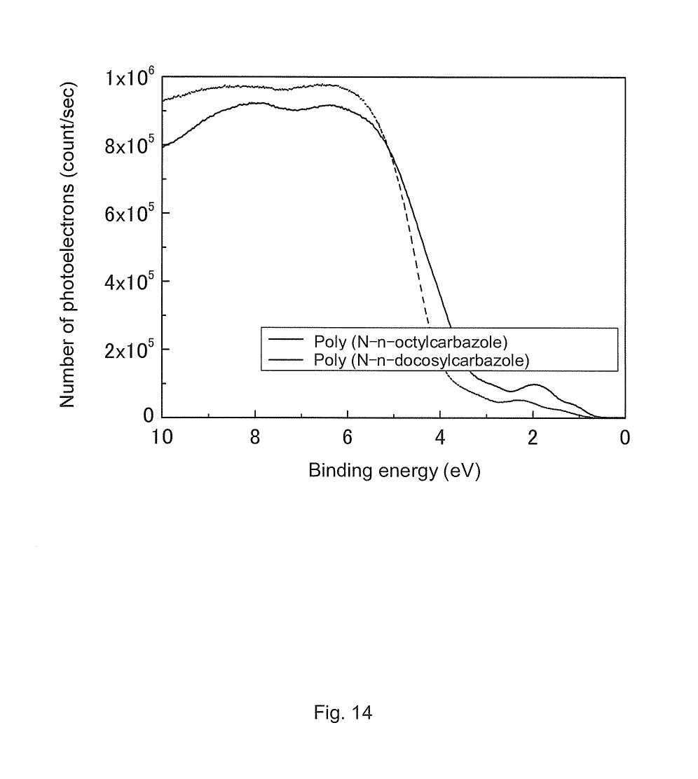

0.1 g of the poly(N-n-octylcarbazole) obtained by chemical polymerization in Example 1 was dissolved in 4 mL of chloroform, and the resulting solution was spin-coated on a silicon wafer with a spin-coater (MS-A150, available from Mikasa Co., Ltd.) to form a film. The ionization potential of the film was 5.2 eV measured by the ultraviolet photoelectron spectroscopy. The photoelectron spectrum of the film is shown in FIG. 14.

### Reference Example 16

### Measurement of Ionization Potential of Poly(N-n-docosylcarbazole) Film

0.1 g of the poly(N-n-docosylcarbazole) obtained by chemical polymerization in Example 14 was dissolved in 4 mL of chloroform, and the resulting solution was spin-coated on a silicon wafer with a spin-coater (MS-A150, available from Mikasa Co., Ltd.) to form a film. The ionization potential of the film was 5.0 eV measured by the ultraviolet photoelectron spectroscopy. The photoelectron spectrum of the film is shown in FIG. 14.

### Comparative Example 1

An electrolytic solution containing commercially available carbazole (5 mM) and a dichloromethane solution having tetrabutylammonium perchlorate dissolved therein (0.1 M) was placed in a main chamber of a two-chamber electrolysis cell formed of heat resistant glass. A glass electrode having an ITO film (thickness: 170 nm) coated thereon and a platinum plate electrode were immersed in the main chamber. Separately, an electrolytic solution containing a dichloromethane solution having tetrabutylammonium perchlorate dissolved therein (0.1 M) was placed in a sub chamber, which was isolated from the main chamber with a sintered glass film, and a saturated calomel electrode (SCE) was immersed in the sub chamber. Nitrogen gas was passed through the solution in the main chamber for 40 minutes to eliminate dissolved oxygen. The ITO electrode as a working electrode, the platinum plate electrode as a counter electrode and the SCE as a reference electrode were connected to a potentiostat. A voltage of +1.2 V with respect to the reference electrode was applied to the working electrode. The amount of electricity applied was 50 mC/cm², and nitrogen gas was supplied to the upper space of the electrolytic solutions to maintain a nitrogen atmosphere. The electrolysis cell was placed in a thermostatic chamber during the electrolysis to maintain the electrolysis temperature to 5° C.

According to the procedures, a polycarbazole film having a thickness of 800 nm was formed on the ITO glass electrode. The film did not dissolve in dichloromethane, chloroform and 1,2-dichloroethane, and thus failing to provide an ink.

According to the production method of the present invention, a transparent electroconductive material and an ink for forming a transparent electroconductive material can be conveniently obtained, and can be applied to a display device, such as a liquid crystal display device and an electroluminescence display device. The transparent electroconductive material and the ink for forming a transparent electroconductive material can also be applied to a solar cell, a touch-sensitive panel and the like, and thus are industrially useful.

What is claimed is:

1. A method for producing a transparent electroconductive material, the method comprising a step of contacting poly(N-alkylcarbazole) with a metal, said poly(N-alkylcarbazole) is obtained by polymerizing at least one kind of N-alkylcarbazole represented by the following general formula, 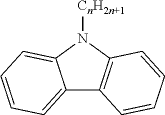
wherein n represents an integer of 1 or more, and at least one hydrogen in the alkyl may be replaced by at least one group selected from hydroxyl, carboxyl, sulfo and amino.

2. The method for producing a transparent electroconductive material according to claim 1, wherein the step of contacting poly(N-alkylcarbazole) with a metal is performed in a liquid phase.

3. The method for producing a transparent electroconductive material according to claim 1, wherein the metal used in the step of contacting poly(N-alkylcarbazole) with a metal is a molten metal.

4. The method for producing a transparent electroconductive material according to claim 1, wherein poly(N-alkylcarbazole) is obtained by chemical polymerization.

5. A transparent electroconductive material produced by the method according to claim 1.

6. A method for producing an ink for forming a transparent electroconductive material, the method comprising the steps of:
a) dissolving poly(N-alkylcarbazole) in a solvent to form a poly(N-alkylcarbazole) solution, said poly(N-alkylcarbazole) is obtained by polymerizing at least one kind of N-alkylcarbazole represented by the following general formula, 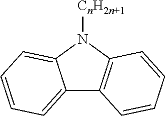
wherein n represents an integer of 1 or more, and at least one hydrogen in the alkyl may be replaced by at least one group selected from hydroxyl, carboxyl, sulfo and amino; and
b) contacting said solution with a metal.

7. A method for producing an ink for forming a transparent electroconductive material, the method comprising a step of contacting a poly(N-alkylcarbazole) solution with a metal, said poly (N-alkylcarbazole) solution is obtained by chemical polymerization of at least one kind of N-alkylcarbazole represented by the following general formula in a solvent, 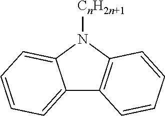
wherein n represents an integer of 1 or more, and at least one hydrogen in the alkyl may be replaced by at least one group selected from hydroxyl, carboxyl, sulfo and amino.

8. The method for producing an ink for forming a transparent electroconductive material according to claim 6, wherein poly(N-alkylcarbazole) is obtained by chemical polymerization.

9. An ink for forming a transparent electroconductive material produced by the method according to claim 6.
